(19) United States
(12) Patent Application Publication
(10) Pub. No.: US 2018/0322576 A1
(43) Pub. Date: Nov. 8, 2018

(54) ORDER LIFE-CYCLE VISUALIZATION

(71) Applicant: Nasdaq Technology AB, Stockholm (SE)

(72) Inventors: Ingo NEUMANN, Sydney (AU); Andreas FURCHE, Daintree (AU)

(21) Appl. No.: 16/032,740

(22) Filed: Jul. 11, 2018

Related U.S. Application Data
(63) Continuation of application No. 13/873,943, filed on Apr. 30, 2013, now abandoned.

(51) Int. Cl. G06Q 40/04

(52) U.S. Cl. CPC G06Q 40/04

(57) ABSTRACT

Systems and methods are presented that provide a visualization for displaying an order life-cycle for one or more orders. The visualization includes one or more order objects representing orders for financial instruments (e.g., stocks, bonds, securities) and connectivity between the one or more order objects to help show an order history for the order objects. The visualization shows how orders develop over time by allowing a more specific order life-cycle to be emphasized in the visualization. The systems and methods described below allow for direct visibility for the development of orders over time using a unique and interactive visualization.

### CROSS-REFERENCE TO RELATED APPLICATIONS

This application is a Continuation of U.S. patent application Ser. No. 13/873,943 filed Apr. 30, 2013, the entire contents of which are incorporated herein by reference.

### BACKGROUND

Exchanges of many types have existed for centuries. The very first stock exchange, for example, is rumored to have been created in Europe in the 17th century. These exchanges have allowed brokers and traders to trade stocks, bonds, and other securities.

Electronic exchange systems have been developed in recent years for allowing brokers, traders, and other parties to more efficiently and more seamlessly conduct exchange of these instruments. These electronic exchange systems process millions of orders on a daily basis.

As these trading systems process large volumes of data on a daily basis, many systems provide tools for reporting trading information to users. For example, trading “tickers” provide information in an easy to understand scrolling display where different entities stock prices are shown, real-time in the “ticker.” Likewise, users can also see how much a stock price may rise/fall over a period of time on a simple 2-D graph.

Many reporting tools display relatively simple information such as the company name and current price of a stock on a stock “ticker,” for example. But, some reporting tools exist that can show general information relating to orders in the form of a graph or 3-D virtual display. However, these systems fail to provide an easy to follow visualization that can shows an order life-cycle. That is, these visualizations fail to provide information related to the history of an order during the life-cycle of a particular order. Thus, there is a need for an improved visualization that takes into account these drawbacks.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

Systems and methods are presented that provide a visualization for displaying an order life-cycle for one or more orders. The visualization includes one or more order objects representing orders for financial instruments (e.g., stocks, bonds, securities) and connectivity between the one or more order objects to help show an order history for the order objects. The visualization shows how orders develop over time by allowing a more specific order life-cycle to be emphasized in the visualization. The systems and methods described below allow for direct visibility for the development of orders over time using a unique and interactive visualization.

A method implemented in an information processing apparatus having one or more processors and for displaying a visualization for order activity includes receiving order data for one or more broker accounts from one or more broker devices, the order data including one or more order messages for one or more financial instruments, generating a graph, configured to be displayed on a display device, with a time scale displayed along a first axis of the graph and an order value scale displayed along a second axis of the graph, populating, via the one or more processors, the generated graph with one or more order objects for the one or more orders, and connecting, on the generated graph, the one or more order objects using one or more drawn lines, the connected one or more order objects representing an event cycle for the one or more orders.

Another aspect of the technology relates to a non-transitory computer-readable storage medium having computer readable code for displaying a visualization for order activity which, when executed by a computer having one or more processors, performs functionality comprising receiving order data for one or more broker accounts from one or more broker devices, the order data including one or more order messages for one or more financial instruments, generating a graph, configured to be displayed on a display device, with a time scale displayed along a first axis of the graph and an order value scale displayed along a second axis of the graph, populating, via the one or more processors, the generated graph with one or more order objects for the one or more orders, and connecting, on the generated graph, the one or more order objects using one or more drawn lines, the connected one or more order objects representing an event cycle for the one or more orders.

Another aspect of the technology relates to an information processing apparatus, comprising a memory configured to store order data for one or more broker accounts and one or more processors coupled to the memory and configured to display a visualization for order activity. The one or more processors are further configured to perform functionality comprising accessing one or more broker accounts and retrieving transaction data corresponding to one or more financial transactions involving the one or more broker accounts, generating a graph with a time scale displayed along a first axis and a value scale displayed along a second axis, the graph including one or more points corresponding to the one or more financial transactions, and connecting the one or more points via one or more lines drawn between the one or more points, the one or more lines representing an event history for the one or more financial transaction.

Another aspect relates to an information processing system having one or more broker devices communicating and providing financial transaction data to the information processing apparatus of the preceding paragraph.

In a non-limiting, example implementation the order value scale comprises one or more value components containing a price of the one or more orders.

In another non-limiting, example implementation the order value scale comprises one or more value components containing a price and a volume of the one or more orders.

In yet another non-limiting, example implementation the one or more order objects comprise one or more sizes corresponding to an order volume for the one or more orders.

In another non-limiting, example implementation the one or more order objects are associated with one or more display colors corresponding to a type of order for the one or more order objects.

In yet another non-limiting, example implementation the one or more order objects are associated with multiple display shapes representing at least one or an entered order, an amended order, a deleted order, and/or a market order.

In another non-limiting, example implementation a selection operation on one of the one or more connected orders focuses the event cycle for the selected order.

In yet another non-limiting, example implementation an overlay window is generated when one of the one or more order objects are selected, the overlay window providing detailed information for the selected order object.

In another non-limiting, example implementation all trades executed by one of the one or more orders are highlighted when a selection operation is performed on the selected order object.

### BRIEF DESCRIPTION OF THE DRAWINGS

FIG. 1 is a block diagram of an electronic exchange system interacting with a broker device;

FIG. 2 is a block diagram showing a broker device processing one or more trades with the electronic exchange system;

FIG. 3 is an example diagram of a visualization for displaying order activity without order visualization being displayed;

FIG. 4 is an example diagram of a visualization for displaying order activity with order visualization being displayed;

FIG. 5 is an example diagram of a visualization for displaying order activity with order visualization being displayed and emphasis of one or more orders and order life-cycles; and

FIG. 6 is an example flowchart describing a process for generating a visualization for displaying order activity.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models, and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the technology, and does not imply that the illustrated process is preferred.

Various forms of computer readable media/transmissions may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

The technology described below is directed to a visualisation that allows observers to see how the order life-cycle of one or more orders develop over time. This can be useful for surveillance because, at a glance, it helps to identify trading patterns which would otherwise be non-obvious when viewing standard spread graphs, for example. By using such visualizations, the development of orders over time is directly visible to a user using an interactive visualization.

Current order visualizations are much less sophisticated as they simply plot the orders at their price and time. The current order visualizations do not provide order tracking or any other graphical order visualization over time to visualize the order life-cycle. The technology described herein improves upon such drawbacks by providing a visualization capable for showing an order life-cycle for one or more orders.

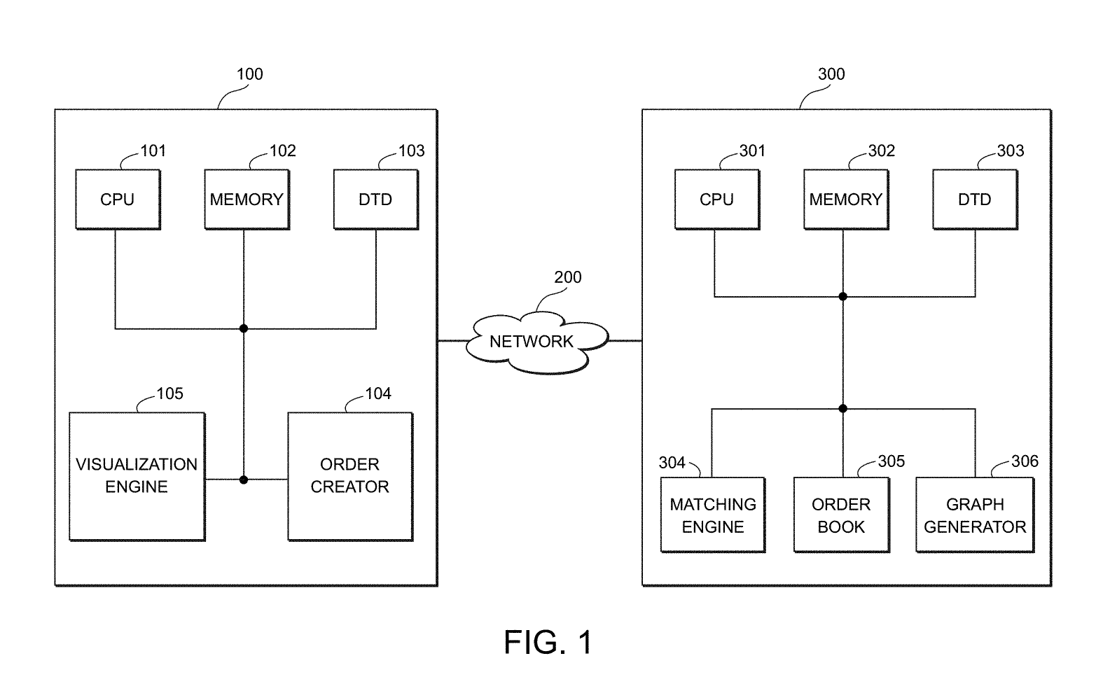

FIG. 1 is an example diagram showing an electronic exchange system 300 communicating with at least one broker device 100 via a network 200. The broker system 100 can be implemented with and/or used via a personal computer, a PDA device, a cell phone, a server computer, or any other system/device for conducting the electronic exchange described herein. It should also be appreciate that the broker system 100 is not limited to a broker but can be any individual and/or business conducting electronic exchange of financial instruments. It should also be appreciated that the electronic exchange 300 communicates with a plurality of broker systems 100 to match orders.

The broker system 100 includes a central processing unit (CPU) 101, a memory 102, and a data transmission device 103. The data transmission device (DTD) 103 can be, for example, a network interface device that can connect the broker system 100 to the network 200. The connection can be wired, optical, or wireless and can connect over a Wi-Fi network, the Internet, or a cellular data service, for example. The data transmission device 103 can also be an input/output device that allows the broker system 100 to place the data on a computer-readable storage medium. It should be appreciated that the data transmission device 103 is capable of sending and receiving data (i.e. a transceiver).

The broker system 100 can be used for conducting exchange of financial instruments with the electronic exchange system 300. The broker system 100 can take an order from a user and then generate an order message using the order creator 104. Upon finishing the order, the order creator 104 transmits the order over the network 200 using the data transmission device 103. The electronic exchange system 300 then receives the order for processing. The broker device 100 is also configured to have a visualization engine 105 that is capable of generating and displaying a user interface and visualization for trade activity. The visualization can be created by data received from the electronic exchange system 300 and/or one or more broker devices 100. Likewise, the data for generating the visualization can be generated at the exchange system 300 or can be generated by the broker device 100.

The electronic exchange system 300 includes a CPU 301, a memory 302, and a data transmission device 303. In a preferred example embodiment, the electronic exchange system 300 may include multiple processors and/or memories and may be designed for fail-safe redundancy. The data transmission device (DTD) 303 can be, for example, a network interface device that can connect the exchange 300 to the network 200. It should be appreciated that the data transmission device 303 is capable of sending and receiving data (i.e. a transceiver).

The electronic exchange system 300 also has a matching engine 304, implemented using one or more processors, for matching orders received from one or more broker devices 100 and an order book memory 305 for storing orders. It should be appreciated that the order book 305 can exist in the memory 302 of the corporate debt options exchange 300. The electronic exchange system 300 is also configured to have a graph generator 306 for generating graph data for displaying the visualization. The graph generator 306 is capable of compiling data so that one or more broker devices 100 may render the visualization directly from the compiled data. Likewise, the graph generator 306 is also capable of generating display data that can be transmitted to one or more broker devices 100 where the broker devices 100 can display the graph via one or more display devices associated with the broker device 100.

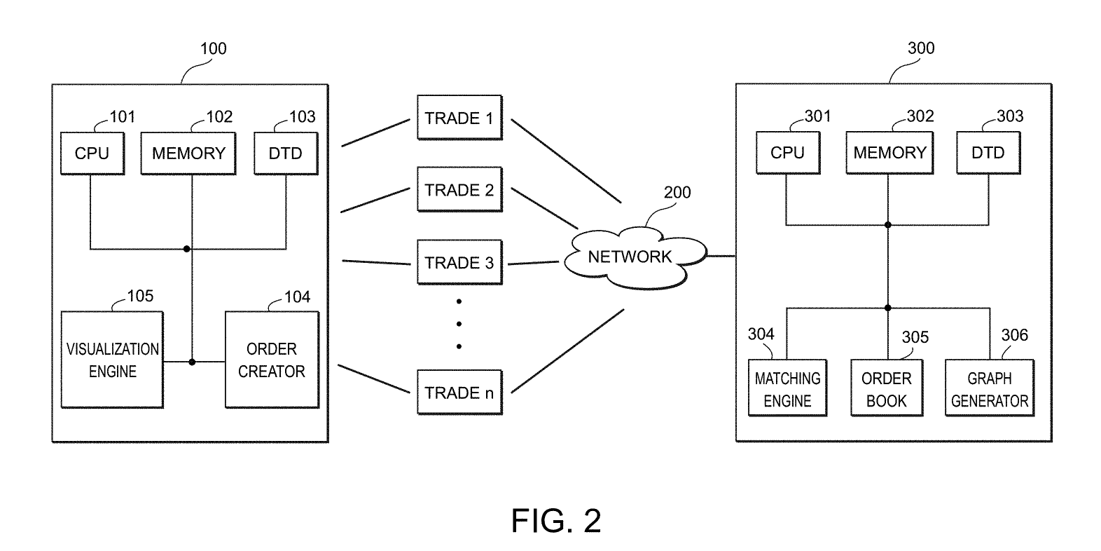

FIG. 2 shows an example block diagram showing a broker device 100 processing one or more trades with the electronic exchange system 300. In the example shown in FIG. 2, the broker device 100 communicates trade/order messages for orders 1-n to the electronic exchange system 300 via the network 200. As explained above, the orders can be generated via a user interface at the broker device 100 or can be created automatically by the device 100 and sent as order data messages using the order creator 104.

The electronic exchange system 300 is capable of matching, via the matching engine 304, the orders 1-n with orders in the order book 305. The electronic exchange system 300 is also capable for storing history data for the orders in the memory 302. By having history data for the orders, the graph generator 306 is capable of generating data for rendering a visualization that displays trading activity for one or more client accounts. The generated graph data can then be transmitted to one or more broker devices 100 where the visualization engine 105 on the broker device 100 is capable of generating the displayed visualization. In an example embodiment, the broker device 100 will have an input interface for a user to display the visualization and interact with the visualization.

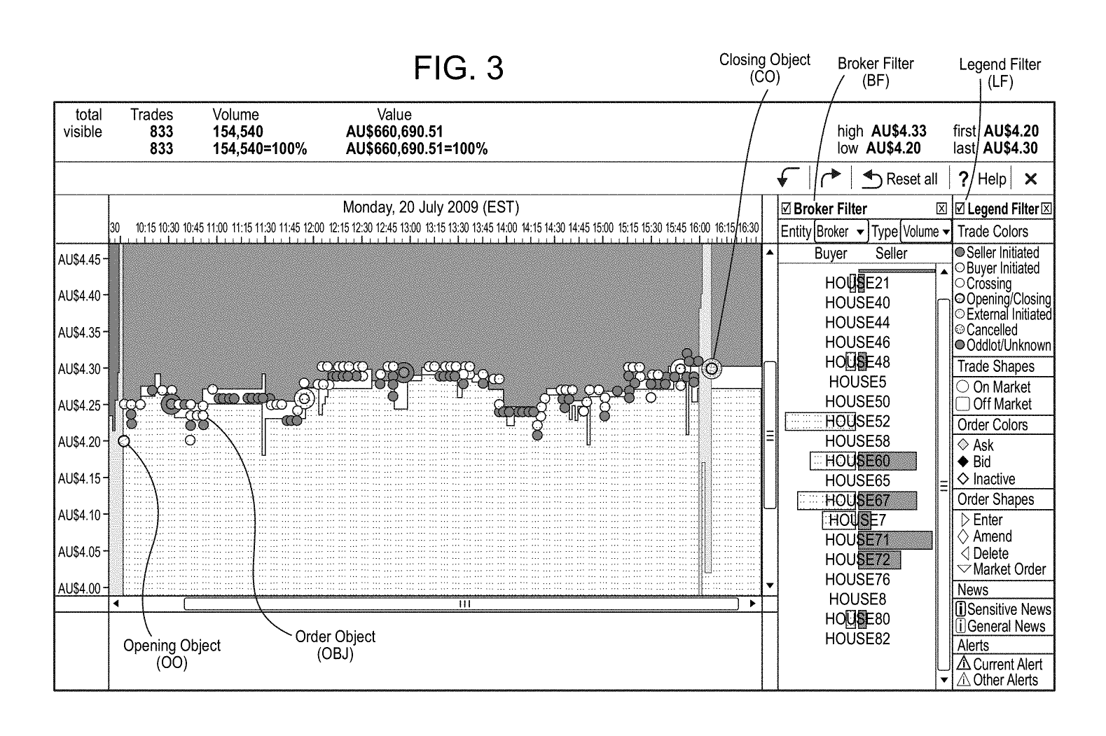

FIG. 3 is an example diagram of a visualization for displaying order activity for one or more client accounts and/or one or more broker accounts. Although not limited to the diagram shown in FIG. 3, the visualization can have a time scale along a first axis (e.g., the X-axis). The visualization can also have a price, volume, or value (price * volume) along a second axis (e.g., the Y-axis). It should be appreciated that the scale along the second axis can be selected by a user or determined based on the underlying visualization for the scale.

The orders shown in FIG. 3 can be represented with one or more order objects (OBJ) for the order. The example shown in FIG. 3 also shows orders for a single day where opening object (OO) and closing object (CO) represent the beginning and ending time period for order processing during that day, respectively. An exchange may have different periods of time where opening/closing of the exchange will occur. For example, an exchange can have a “pre-market session” from 7 AM to 9:30 AM, a “normal trading session” from 9:30 AM to 4 PM, and a “post-market session” from 4 PM to 8 PM.

In the visualization shown in FIGS. 3-5, all orders are plotted at the time they occurred (e.g., along the X-axis). The y-position for each order can depend on the underlying y-scale. In one example implementation, the visualization can plot orders at their price (or current market price for Market-Orders) along the Y-axis. In another example implementation, orders can be potted at their value (price * volume or current market value for Market-Orders).

The visualization shown in the diagram of FIGS. 3-5 is also capable of including a broker filter BF for filtering one or more types of a variety of entities. In the example shown in FIG. 3, the broker filter BF is showing order data for a broker entity with the volume for each broker. The broker filter BF, which allows selection of trading entities, also works as per an Equity visualization, such that trades (and orders) by a particular Security/Trader/House can be identified by applying a colour mask. Of course, the entity and filter type are not limited to broker and a volume amount and can be a variety of different options. For example, an entity type could be all possible trading entities such as an exchange member, a broker firm, an actual broker, or a market maker. Likewise, a filter type could be a financial instrument type (e.g., a trade-able asset of any kind) such as equity class types as stocks/shares, stock options, equity futures or other so called exotic instruments. There are also debt type class instruments such as bonds/loans, bond futures, options on bond futures, and/or interest rate swaps. Likewise, there may also be ETFs, and foreign exchange (FX) type of instruments such as spot FX, currency futures and various options of FX products.

Within the broker filter BF are one or more brokers listed vertically. The one or more brokers can have at least one volume indicator (VI) which, in the examples shown in FIGS. 3-5, is a bar graph representation of the amount of volume for buying/selling transactions for each broker. The bar graph representing the volume can be proportional to the number of orders for that broker displayed in the visualization.

Although not shown in FIG. 3, when a trade object OBJ is selected, via a user interface for example, further information of the trade is provided. More specifically, an overlay window is generated providing further details of the trade data represented by the selected trade object OBJ.

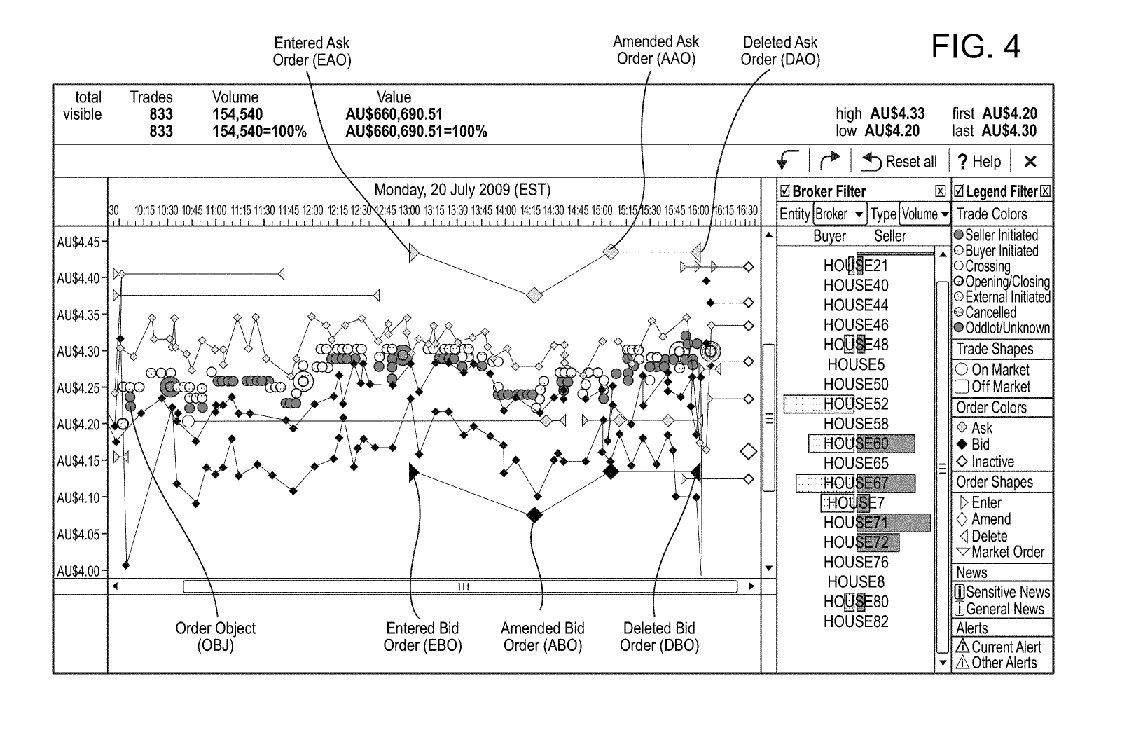

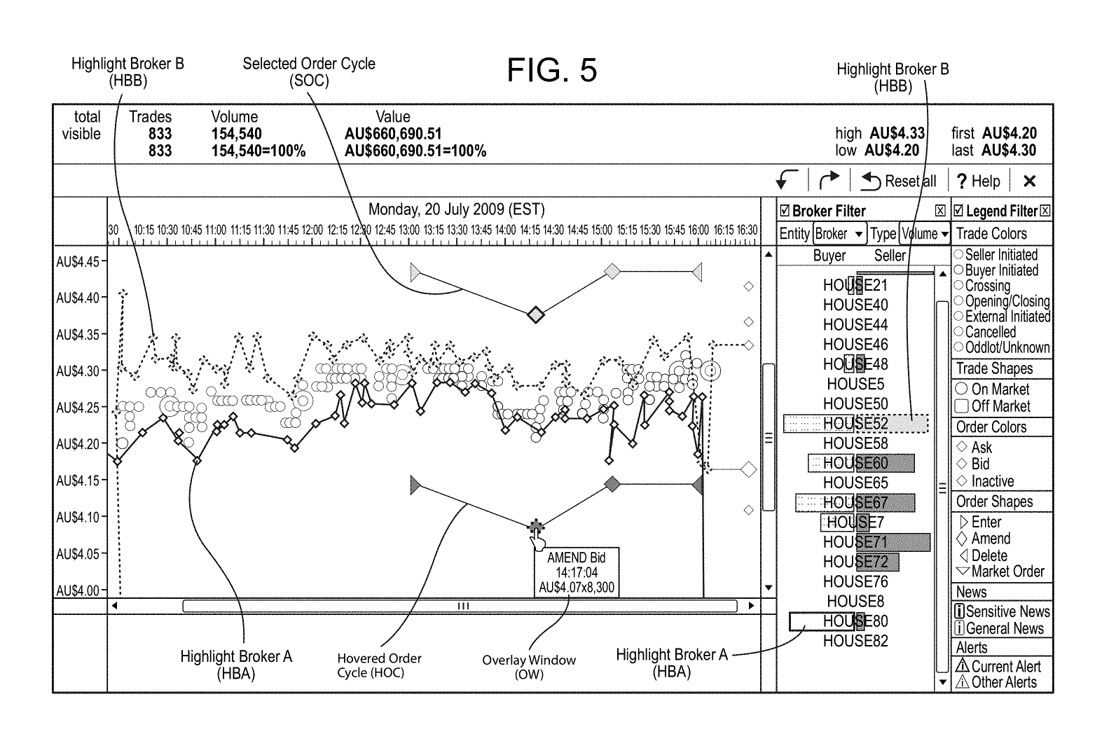

FIG. 4 is an example diagram of a visualization for displaying order activity with order visualization being displayed. Similar to FIG. 3, multiple order objects OBJ are plotted on the display representing one or more orders. In FIG. 4, one or more lines connect the one or more order objects OBJ aiding a viewer of the visualization to see an order/event history of the one or more orders. Belonging orders (e.g., order life-cycle, order-chain, order-trail, entered, amended, deleted, Market-Order) can be visually connected with the lines to show the event history. The lines shown in FIGS. 4 and 5 are straight lines but, of course, are not limited to straight lines and could also be orthographic lines, for example. Although not shown in FIG. 4, order objects OBJ and connection lines are input sensitive and if hovered over one of the objects OBJ (or lines) with an input, an entire order life-cycle can be visually highlighted. Likewise, an input operation for selecting an object OBJ (or line) can indefinitely select and highlight the order life-cycle for further details. It should be appreciated that the described embodiment is not limited to a single selection, and envisions selecting multiple order objects OBJ and/or connection lines.

It should also be appreciated that a color of a shape of one or more order objects OBJ can indicate an order type (e.g., ask, bid, inactive). Likewise, a size of a shape of the one or more order objects can indicate an order volume. Order shapes can also be determined by the status of a particular order (e.g., entered, amended, deleted, Market-Order). As shown in FIG. 4, order life-cycle is shown for a particular order for both ask and bid orders. The order shapes can correspond to a status of an order (e.g., entered, amended, deleted, Market-Order) and the legend for the order shape is shown in the legend filter LF. In the example shown in FIG. 4, an order life-cycle for an order of bid type is shown having the beginning of the cycle starting with an entered bid order (EBO). The life-cycle in this example includes two amended bid orders (ABO) and concluding with a deleted bid order (DBO). It should be appreciated that a deleted bid order may occur when an order completes (i.e., matched) and/or when an order may have been canceled.

In the example shown in FIG. 4, a life-cycle for a corresponding ask order is shown. Similar to the bid order, the life-cycle for an ask order begins with an entered ask order (EAO). The life-cycle in this example also includes two amended ask orders (AAO) and concludes with a deleted ask order (DAO). Thus, the visualization as shown in FIG. 4 allows a user to easily see the creation, progression, and completion of an order by linking the statuses of the order during the period of time in which the order processes. The visualization of the present technology offers further flexibility and interactivity in helping users visualize order life-cycles.

It should be noted that the diagrams shown in FIGS. 3-5 depict a robust visualization pertaining to a variety of orders for a security that is not realized using a standard stock chart. For example, the visualization shown in FIG. 4 appears as a normal stock chart showing instrument prices and trades over time. A major difference however is that orders are visualized where each order has its own path. For example, the path for an order begins at the order entry price and/or time. When an order is amended/corrected, a new plotting point in the visualization will be created at the amended/corrected price and/or time. Cancellation or completion of the order will result in termination of the path at the cancellation/completion time. For example, FIG. 4 shows a path starting with Entered Bid Order EBO (e.g., order creation) connecting to Amended Bid Orders ABO (e.g., order amendment/correction) and ending with Deleted Bid Order DBO (e.g., order cancellation). Furthermore, and as discussed further below, a “mouse-over” event over a path will also create a highlight of the path. Thus, the history of the order can be easily visualized for the user by displaying the history along the charted path, and the visualization provides a sense of depth on each side of an order book over time.

In addition to showing the charted history of the order, the visualization shows “nodes” (represented by Order Objects OBJ, for example) where the “node” for the order will have a size reflecting the size of the particular order. That is, the size of the “node” is a reflection of the order size (e.g., order price, order volume, order volume/order value). For example, an order for 100 shares of IBM® stock at $100 per share will have an Order Object OBJ smaller in size than an order for 250 shares of Apple® stock at $400 per share.

FIG. 5 is an example diagram of a visualization for displaying order activity with order visualization being displayed and emphasis of one or more orders and order life-cycles. Similar to FIG. 4, one or more order objects OBJ are plotted on the display and connected by drawn lines. As discussed briefly above, by way of an input operation, one or more order objects OBJ and their connecting lines may be selected. In selecting the objects OBJ and/or their respective connecting lines, an order life-cycle can be emphasized (e.g., highlighted) on the display.

In the example shown in FIG. 5, highlighted broker A is selected where the volume portion for highlighted broker A is emphasized in the broker filter BF in a first color (e.g., yellow). In the visualization, highlighted broker A may have one or more order objects OBJ for the broker where these orders may be connected by the drawn lines. Although not limited to this example, the order objects OBJ and drawn lines for highlighted broker A will be emphasized with the same first color (e.g., yellow). The example in FIG. 5 also shows highlighted broker B with a highlighted volume portion in the broker filter BF and a corresponding highlighted one or more order objects OBJ in the display in a second color (e.g., purple). It should be appreciated that by emphasizing the orders for a specific broker, highlighted trades and life-cycles for all orders for that broker can be easily seen. That is, by allowing specific selection for one or more brokers, the user is provided with an easy-to-follow visualization for following order life-cycles for one or more orders for that specific broker.

In addition to highlighting order objects OBJ and their respective connecting lines for one or more brokers, a single order life-cycle can be selected and emphasized. In the example shown in FIG. 5, a selected order cycle (SOC) is shown where a user, for example, can perform an input operation on the order life-cycle (e.g., a mouse click). In doing so, the order life-cycle (e.g., the ask order life cycle as shown in FIG. 4), is selected and highlighted in a third color (e.g., orange). Thus, each single order can be selected so that a user can easily see an order life-cycle over a given period of time.

On the display, an order life-cycle or order object OBJ can also be “hovered” over via an input operation (e.g., a mouse-over “hover” operation). In the example shown in FIG. 5, a hovered order cycle (HOC) (e.g., the bid order life cycle as shown in FIG. 4) is being hovered over via an input operation. The hovered order cycle HOC will allow the order path to be highlighted, similar to the highlighting for a selected order cycle SOC (but ideally highlighted with a different color). Although not limited to this embodiment, when a hover operation occurs over an order object OBJ or an order life-cycle, an overlay window (OW) can be generated that provides further detail of the object. In this example shown in FIG. 5, the hovered-over object shows the status “AMEND” for “Bid” type at a specific time and value amount in the overlay window (OW). Thus, a user can inquire into each order object by simply “hovering” over the object to produce more detail about the object.

It should also be appreciated that the visualization can be configured so that when holding down an input key while “hovering” over an order object OBJ or life-cycle, all trades that are executed by that order can be highlighted. Likewise, hovering over a trade can highlight which orders executed the trade. It should also be appreciated that the existing Trade/Order History and Replay views (which display orders in a tabular way) are synchronized with any order life-cycle selection form Spread View (which is an interactive graphical interface that consolidates data across asset classes and global market venues into a single intuitive snapshot to rapidly detect infringements) and vice-versa. This includes also the amendment list shown in the Replay postits (which is a mechanics enabling replay of any transaction for any security during any time period).

It should be appreciated that the term “order” can encompass more than simply an order from a buyer to a seller and vice-versa. For example, an “order” could include a market maker quotation. As will be understood by one of ordinary skill in the art, a market maker is an entity (e.g., company, individual) that quotes both a buy and a sell price in a financial instrument or commodity held in inventory hoping to turn a profit on the bid-offer spread or turn. Thus, the term “order” can also encompass a market maker quote and an order object OBJ can reflect a market maker quote. Thus, the visualization can show orders for brokers/parties buying/selling with another broker/party and can also show market makers entering quotes that quote both a buy and a sell price in a financial instrument.

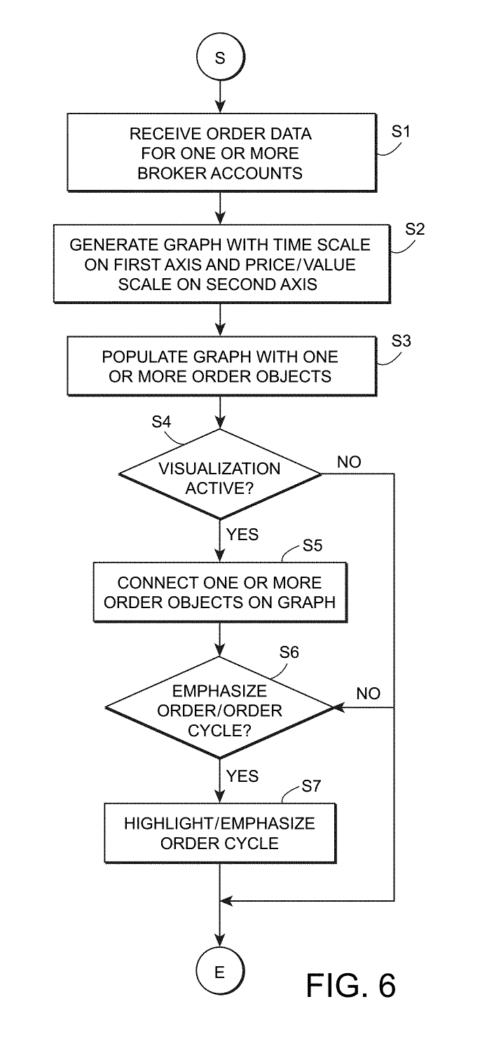

FIG. 6 is an example flowchart describing a process for generating a visualization for displaying order activity. The processes and descriptions described in FIG. 6 can be implemented by one or more broker devices 100 and/or one or more electronic exchanges 300. The processes and descriptions allow for implementation of the visualization for order tracking described herein.

The process begins by receiving order data for one or more broker accounts (S1). The order data can be received via one or more order messages, for example. Using the order data, the system can generate a graph with a time scale on a first axis (e.g., X-axis) and a price, value, and/or volume scale on a second axis (e.g., Y-axis).

Once the graph is generated, the graph can be populated with one or more order objects OBJ (S3) representing one or more orders in the order data. The system can determine if it should display the visualization for showing an event history/order life-cycle for one or more orders (S4). If the visualization is to be displayed, one or more order objects OBJ may be connected by, for example, drawn lines in the graph (S5). As discussed above, by connecting the one or more order objects OBJ, the depth of the order book can be analyzed via an easy to use and easy to view visualization.

The system is further configured to determine if one or more order objects OBJ and/or order life-cycle have been selected to be emphasized (S6). If an order object OBJ and/or order life-cycle has been selected for emphasis, the visualization may display the emphasis by, for example, highlighting the order life-cycle and/or order chain in the display.

The order visualization described herein is advantageous as it illustrates the depth of an order book in a unique manner The depth of the order book is further analyzed by way of input highlighting and filtering features as discussed above. Such a visualization can, for example, allow traders and/or compliance officers to identify various order/trading strategies like algorithmic or high-frequency trading as well as suspicious order placements.

While the technology has been described in connection with what is presently considered to be the most practical and preferred embodiment, it is to be understood that the technology is not to be limited to the disclosed embodiment, but on the contrary, is intended to cover various modifications and equivalent arrangements.

1. A method implemented in an information processing apparatus having a memory, a transceiver, and one or more processors and for displaying a visualization for order activity, comprising:
receiving, via the transceiver, order data for one or more broker accounts from one or more broker devices, the order data including one or more order messages for one or more orders for one or more financial instruments;
generating a graph, via the one or more processors, configured to be displayed on a display device, with a time scale displayed along a first axis of the graph and an order value scale displayed along a second axis of the graph;
populating, via the one or more processors, the generated graph with one or more order objects, wherein:
each of the one or more order objects is associated with an order from the one or more orders, and each of the one or more order objects represents an event in a life-cycle of the order with which the order object is associated; and
for at least one of the one or more orders, the order objects associated with the order represent events in the life-cycle of the order that include:
entry of the order;
amendment of the order; and
deletion of the order; and
drawing, via the one or more processors, one or more lines on the generated graph, wherein the one or more lines connect the order objects that are associated with a same order from the one or more orders.

2. The method of claim 1, wherein the order value scale comprises one or more value components containing a price of the one or more orders.

3. The method of claim 1, wherein the order value scale comprises one or more value components containing a price and a volume of the one or more orders.

4. The method of claim 1, wherein the one or more order objects are associated with one or more display colors corresponding to a type of order for the one or more order objects.

5. The method of claim 1, wherein the one or more order objects are associated with multiple display shapes representing at least one of an entered order, an amended order, a deleted order, and a market order.

6. The method of claim 1, further comprising:
receiving a selection operation on one of the one or more connected order objects; and
highlighting the order objects that are associated with the order associated with the selected order object.

7. The method of claim 1, further comprising generating, via the one or more processors, an overlay window when one of the one or more order objects are selected, the overlay window providing detailed information for the selected order object.

8. The method of claim 1, further comprising highlighting, via the one or more processors, all trades executed by one of the one or more orders when a selection operation is performed on an order object from the one or more order objects.

9. The method of claim 1, wherein the one or more order objects show trading patterns for the one or more orders over time.

10. An information processing apparatus, comprising:
a transceiver configured to send and receive order data;
a memory configured to store the order data for one or more broker accounts; and
one or more processors operatively associated with the memory and the transceiver and configured to display a visualization for order activity, the one or more processors further configured to perform actions that include:
receiving order data for one or more broker accounts from one or more broker devices, the order data including one or more order messages for one or more orders for one or more financial instruments;
generating a graph, configured to be displayed on a display device, with a time scale displayed along a first axis of the graph and an order value scale displayed along a second axis of the graph;
populating, via the one or more processors, the generated graph with one or more order objects, wherein:
each of the one or more order objects is associated with an order from the one or more orders, and each of the one or more order objects represents an event in a life-cycle of the order with which the order object is associated; and
for at least one of the one or more orders, the order objects associated with the order represent events in the life-cycle of the order that include:
entry of the order;
amendment of the order; and
deletion of the order; and
connecting, on the generated graph, the one or more order objects using one or more drawn lines, wherein the one or more drawn lines connect the order objects that are associated with a same order from the one or more orders.

11. The information processing apparatus of claim 10, wherein the event represented by each of the one or more order objects is: entry of the given order; amendment of the given order; or deletion of the given order.

12. The information processing apparatus of claim 10, wherein the one or more order objects are associated with one or more display colors corresponding to a type of order for the one or more order objects.

13. The information processing apparatus of claim 10, wherein the one or more order objects are associated with multiple display shapes representing at least one or an entered order, an amended order, a deleted order, and a market order.

14. The information processing apparatus of claim 10, wherein the one or more processors are further configured to:
generate an overlay window when one of the one or more order objects are selected, the overlay window providing detailed information for the selected order object.

15. The information processing apparatus of claim 10, wherein the one or more processors are further configured to:
highlight all trades executed by one of the one or more orders when a selection operation is performed on an order object from the one or more order objects.
